(19) United States
(12) Patent Application Publication
(10) Pub. No.: US 2018/0237092 A1
(43) Pub. Date: Aug. 23, 2018

(54) ENERGY SUPPLY CIRCUIT FOR A LIGHTING MODULE

(71) Applicant: ZKW Group GmbH, Wieselburg (AT)

(72) Inventor: Thomas GRAF, Pottenbrunn (AT)

(21) Appl. No.: 15/752,289

(22) PCT Filed: Aug. 29, 2016
(86) PCT No.: PCT/AT2016/060045

§ 371 Date: Feb. 13, 2018

(30) Foreign Application Priority Data
Sep. 2, 2015 (AT) A 50751/2015

(51) Int. Cl. B62J 6/00; H05B 37/02; H05B 33/08; F21S 41/141; B62J 6/02

(52) U.S. Cl. CPC B62J 6/001; H05B 37/02; B62J 6/02; F21S 41/141; H05B 33/0815

(57) ABSTRACT

The invention relates to an energy supply circuit (5) for a lighting module (4) for a motor-vehicle headlamp, wherein the lighting module (4) comprises a shunt resistor (Rₛₑₓₜ) and at least one light source (D1, D2, Dn) that can be electrically supplied at least partially via the shunt resistor (Rₛₑₓₜ), wherein the lighting module (4) also has at least three electrical connections (A1′, A2′, A3′), wherein a first connection (A1′) and a second connection (A2′) are provided for electrically contacting the shunt resistor (Rₛₑₓₜ) and a third connection (A3′) is provided for electrically contacting the at least one light source (D1, D2, Dn) connected downstream, wherein the electrical connections (A1′, A2′, A3′) are designed as externally contactable connections, wherein the energy supply circuit (5) has a control unit (3) for outputting a supply current (Iv) controlled so as to be constant to the at least one light source (D1, D2, Dn) of the lighting module (4), wherein the control unit (3) has an auxiliary resistor (Rs), which is connected in parallel with the shunt resistor (Rₛₑₓₜ).

The invention relates to a lighting module for a motor vehicle lighting device, in particular for a motor vehicle headlight. The invention further relates to an energy supply circuit for a lighting module for a motor vehicle headlight, wherein the lighting module includes a shunt resistor and at least one light source that can be electrically supplied, at least partially, via the shunt resistor, wherein the lighting module also has at least three electrical connections, wherein a first connection and a second connection are provided for electrically contacting the shunt resistor, and a third connection is provided for electrically contacting the at least one light source connected downstream, wherein the electrical connections are designed as externally contactable connections, wherein the energy supply circuit has a control unit for outputting a supply current, controlled to be constant, to the at least one light source of the lighting module, wherein the control unit has at least three electrical connections for connection to the electrical connections of the lighting module, wherein the control unit is configured for conducting at least a portion of the supply current via the shunt resistor toward the at least one light source and measuring the voltage difference present at the shunt resistor, wherein for controlling the current, the voltage difference at the shunt resistor is controlled to a constant value. The invention further relates to a circuit arrangement comprising a lighting module and an energy supply circuit, and to a motor vehicle headlight, and to a motor vehicle that includes the circuit arrangement.

Lighting modules according to the prior art have light sources that may be supplied with power via an external energy supply device. The luminous flux that is emitted by such lighting modules is specified by the power consumed and by the number and efficiency of the light sources installed on the lighting module. Lighting modules for automotive manufacturing, in particular for use in headlights, are often produced in different brightness classes. Lighting modules are usually produced in three brightness classes, with which light sources having a certain efficiency are respectively associated. When lighting modules of different brightness classes are supplied with the same supply current, this results in different quantities of light being emitted by the lighting modules. For installation in a vehicle headlight, this would have the undesirable effect that for a vehicle headlight having a specified light pattern, only a single lighting module could be used, since the intensity of the emitted light would be changed by replacement with a lighting module having a different brightness class.

To counteract this problem, in lighting modules according to the prior art a coding resistor is provided, which is detected by an energy supply circuit corresponding to the lighting module or is evaluated by an evaluation unit situated at the energy supply unit, and a conclusion is drawn concerning the brightness class of the light sources based on the value of the coding resistance. By adapting the supply current (0.6 A to 1 A, for example) to the particular brightness class of the lighting module, it is possible to operate lighting modules of different brightness classes in such a way that the light pattern that is emitted by a lighting module may be substantially the same for lighting modules of different brightness classes. For example, the number of lighting modules that are suitable for a motor vehicle headlight may be increased in this way. However, providing a coding resistor represents a certain level of effort, since the lighting module must be fitted with the resistor, and in addition electrical connections must be provided via which contacting by the evaluation unit of the energy supply unit may take place. Furthermore, the energy supply unit must include the evaluation unit, as well as a control unit that is connected to the evaluation unit and is configured for setting an output voltage or an output current as a function of the measuring result of the evaluation unit. As a result, the information transfer from the lighting module toward the control unit has thus far represented a costly effort.

A lighting module has become known from JP 2009214789 A, in which a current to be fed to light sources is specified via a shunt resistor that is connected in series with the light sources. The voltage at the shunt resistor is controlled to a constant value, resulting in a constant current value, which is proportional to the shunt resistance, being fed to the light sources. The value of the current may be increased by lowering the shunt resistance at a given voltage, with the power loss possibly increasing at the shunt resistor due to the rise in the current. In JP 2009214789 A, the heat loss that is realized at the shunt resistor occurs directly at the lighting module, which already includes light sources having losses. This is particularly disadvantageous, since the lifetime of light sources typically decreases with increasing operating temperature.

Therefore, it is an object of the invention to provide an energy supply circuit for a lighting module, by means of which the disadvantages of the prior art may be overcome. Such a lighting module includes a shunt resistor and at least one light source that can be electrically supplied, at least partially, via the shunt resistor, wherein the lighting module also has at least three electrical connections, wherein a first connection and a second connection are provided for electrically contacting the shunt resistor, and a third connection is provided for electrically contacting the at least one light source connected downstream, wherein the electrical connections are designed as externally contactable connections. This object is achieved by an energy supply circuit of the type mentioned at the outset, in which according to the invention the control unit has an auxiliary resistor that is connected in parallel to the shunt resistor.

As the result of the invention, it is possible to completely dispense with coding means or associated evaluation units according to the prior art, and to map the brightness class of a lighting module directly in the power supply path of the light sources, wherein due to the parallel connection of the auxiliary resistor to the shunt resistor (the auxiliary resistor being part of the control unit), the supplying of power to the light sources via the shunt resistor may be relieved, so that the heat losses at the lighting module may be reduced and the lifetime of the light sources of the lighting module may thus be increased. If the auxiliary current I_{Rs} for supplying power to the light sources, delivered by the auxiliary resistor, is sufficient, the shunt resistor may be selected with corresponding high impedance, so that the current I_{Rse} that is conducted through the shunt resistor to the light sources is negligible compared to the current through the auxiliary resistor. The shunt resistor, in addition to the auxiliary resistor, is generally dimensioned in such a way that, at a given voltage at the shunt resistor, the desired supply current results, which flows through the light sources connected downstream. The voltage difference at the shunt resistor may be measured via the first and second contacts, and as a control variable of a control unit, may be provided to an energy supply circuit. The resistance value of the shunt resistor has a significant influence on the supply current. For example, when a voltage difference at the shunt resistor is controlled to 0.1 V at a resistance value of 0.1Ω, a current having the value of 1 A is specified via the shunt resistor.

In particular, it may be provided that the lighting module has at least two, three, or more than three light sources.

In addition, it may be provided that the at least one light source is an LED, an OLED, or a laser diode. Variants are also conceivable in which multiple LEDs, OLEDs, and/or laser diodes are used. In particular, it may be provided that the shunt resistance has a value between 0.2Ω and 2Ω, preferably between 0.3Ω and 1.5Ω, particularly preferably between 0.5Ω and 1Ω.

To allow a particularly compact and simple design of the lighting module, it may be provided that the shunt resistor, the at least one light source, and the at least three connections are situated on a shared circuit carrier, preferably a printed circuit board.

A further aspect of the invention relates to an energy supply circuit for a lighting module according to one of the preceding claims, having a control unit for outputting a supply current, controlled to a constant value, to the at least one light source of the lighting module, in which according to the invention the control unit has at least three electrical connections for connection to the electrical connections of the lighting module, wherein the control unit is configured for conducting at least a portion of the supply current via the shunt resistor toward the at least one light source and measuring the voltage difference present at the shunt resistor, wherein for controlling the current, the voltage difference at the shunt resistor is controlled to a constant value, for example between 0.05 V and 0.5 V, preferably between 0.1 V and 0.3 V.

The term “voltage difference at the shunt resistor” is understood to mean the voltage that drops at the shunt resistor due to the current flow across same, i.e., the voltage that is present between the first and second connections.

According to the invention, it is provided that the control unit has an auxiliary resistor connected in parallel to the shunt resistor. The supply current is then divided over the resistors, corresponding to the conductances of the resistors. Due to the control to a constant voltage value at the parallel connection made up of the shunt resistor and the auxiliary resistor, the supply current is given by the quotient of the voltage drop at the parallel connection and the equivalent resistance of the parallel connection. When control is carried out to a specified voltage drop, the supply current may thus be easily set at the parallel connection by setting the equivalent resistance, in particular the shunt resistance. Providing the auxiliary resistor, which is connected in parallel to the shunt resistor, allows a minimum current to be applied to the light sources. In addition, such an arrangement ensures that an increased power output to the light sources may be achieved by reducing the shunt resistance, as the result of which the proportion of current delivered via the auxiliary resistor to the total current is increased, the power loss realized at the shunt resistor is reduced, the efficiency of the energy supply circuit may be increased, and in addition the thermal load on the lighting module is reduced.

To avoid the occurrence of undesirable electrical oscillations within the energy supply circuit, in particular within the control circuit of the control unit, it may be provided that the auxiliary resistor is topologically accommodated within the control unit. This means that the auxiliary resistor is situated in the immediate proximity of the remaining components of the control unit, thereby improving the EMC behavior of the energy supply circuit. For this purpose, the auxiliary resistor may also be integrated into an IC that forms the control unit, or may be directly connected thereto.

In particular, it may be provided that the auxiliary resistance has a value between 0.1Ω and 2Ω, preferably between 0.15Ω and 1Ω, particularly preferably between 0.2Ω and 0.75Ω.

It may be particularly advantageous when the control unit for controlling a supply current that is output at the lighting module or for controlling the output voltage correlated with same has a transistor switch connected in series with the lighting module, and a capacitor connected in parallel.

In a further aspect, the invention relates to a circuit arrangement that includes a lighting module according to the invention, and to an energy supply circuit according to the invention for supplying power to the lighting module.

Moreover, the invention relates to a motor vehicle lighting device, in particular a motor vehicle headlight, comprising at least one lighting module and/or one energy supply circuit and/or one circuit arrangement according to the invention. A motor vehicle lighting device is understood to mean any given lighting device that is used for signal light and/or illumination purposes in motor vehicles. Examples of motor vehicle lighting devices include motor vehicle rear lights or taillights, interior lighting, daytime running lights, turn signal lights, navigation lights, fog lights, headlights, backup lights, side marker lights, etc.

Furthermore, the invention relates to a motor vehicle that has at least one, preferably two, motor vehicle headlights according to the invention.

The invention is described in greater detail below with reference to one non-limiting exemplary embodiment that is illustrated in the figures, which show the following:

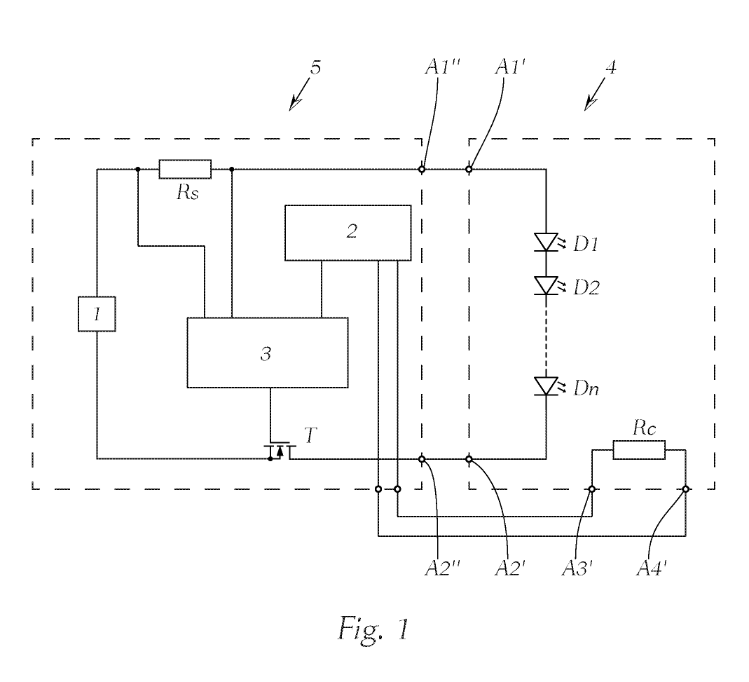

FIG. 1 shows a schematic illustration of a circuit arrangement according to the prior art, and

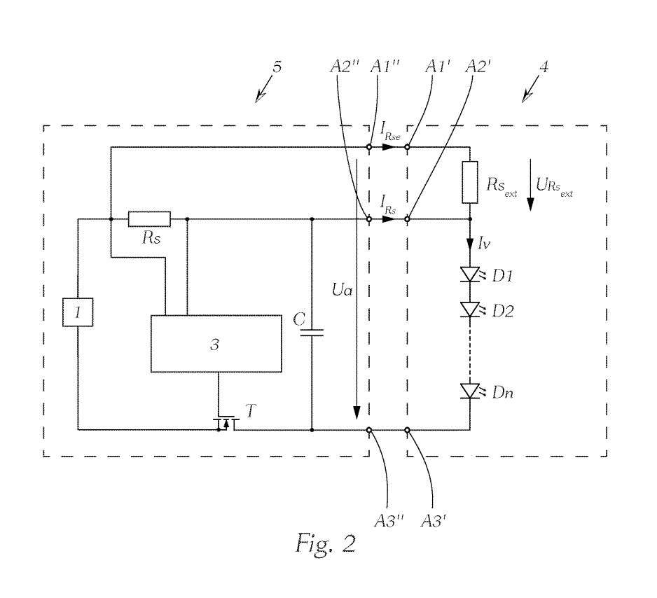

FIG. 2 shows a schematic illustration of a circuit arrangement according to the invention.

Unless stated otherwise, identical reference numerals denote the same features in the figures described below.

FIG. 1 shows a schematic illustration of a circuit arrangement according to the prior art. The circuit arrangement includes a lighting module 4 and an energy supply circuit 5 that supplies power to the lighting module 4. As described in the introduction, the lighting module 4 has multiple light sources D1, D2, through Dn, which may be supplied with power by connections A1″ and A2″ of the energy supply device 5 via the corresponding connections A1′ and A2′. The lighting module has a coding resistor Rc, which via specially designed connections A3′ and A4′ contacts an evaluation unit 2 situated at the energy supply device 5, and may be evaluated. A coding resistor is associated with each brightness class, so that, via the evaluation of the resistance value, conclusions may be drawn concerning the brightness class of the lighting module 4, and a suitable supply current may be set. For this purpose, the evaluation unit 2 is connected to the control unit 3. A power supply unit 1, for example a voltage source, is provided for feeding the energy supply device 5.

FIG. 2 shows a schematic illustration of a circuit arrangement according to the invention, comprising a lighting module 4 according to the invention, and an energy supply circuit 5 according to the invention for supplying power to the lighting module 4. The lighting module 4, in contrast to the prior art, has a shunt resistor Rsₑₓₜ and at least one light source that is electrically supplied, at least partially, via the shunt resistor Rsₑₓₜ; three light sources D1, D2, through Dn are illustrated in the present example. As indicated by the dashed line, the number of light sources may also differ from the number shown. In this exemplary embodiment, light-emitting diodes have been used as light sources. The lighting module 4 has three electrical connections A1′, A2′, and A3′, wherein the connections A1′ (first connection) and A2′ (second connection) are provided for electrically contacting the shunt resistor Rsₑₓₜ. The third connection A3′ is provided for electrically contacting the light sources D1 through Dn, the connections A1′ through A3′ being designed as externally contactable connections in order to be contacted by the energy supply device 5. The power supply unit 1 may be a voltage source, for example, in which the current Iv may be provided by appropriately controlling the transistor T. Any given types of energy sources may generally be used as the power supply unit 1. For example, clocked as well as linear power sources may be used, wherein power supply units that are integrated into the energy supply device 5 or also discretely designed power supply units may be used.

The energy supply device 5 is configured for delivering a constant supply current to the light sources D1 through Dn. For this purpose, the energy supply device has a control unit 3 for outputting a supply current Iv, controlled to a constant value, to the light sources D1 through Dn of the lighting module 4.

In the exemplary embodiment shown, the supply current Iv is made up of two components, namely, a component that flows across the shunt resistor Rsₑₓₜ (I_{Rse}), and a component that flows across an auxiliary resistor Rs (I_{Rs}). The energy supply unit 5 has at least three electrical connections A1″, A2″, and A3″ which correspond to the electrical connections of the lighting module 4. The control unit 3 is configured for measuring the voltage difference U_{Rsext} present at the shunt resistor Rsₑₓₜ (i.e., the electrical potential difference between the connections A1′ and A2′ and A1″ and A2″) and using them as a control variable. For example, a transistor switch T may be controlled via a PWM signal, so that it may be ensured that an output voltage Ua is present between the connections A1′ and A3′, resulting in a desired voltage value (0.1 V or 0.2 V, for example) and thus a desired current at the resistor Rsₑₓₜ. The output voltage Ua may be assisted by a capacitor C.

The auxiliary resistor Rs is typically an integral part of the energy supply circuit 5 and is connected in parallel to the shunt resistor Rsₑₓₜ, thus relieving the shunt resistor Rsₑₓₜ. Providing the auxiliary resistor Rs, which is connected in parallel to the shunt resistor Rsₑₓₜ, allows a minimum current IRs to be applied to the light sources D1 through Dn. In addition, such an arrangement ensures that an increased power output to the light sources D1 through Dn may be achieved by reducing the shunt resistance Rsₑₓₜ, as the result of which the power loss realized at the shunt resistor Rsₑₓₜ is reduced, and the efficiency of the energy supply circuit 5 may be increased. It is important in the invention that the shunt resistor Rsₑₓₜ influences the overall resistance, and thus influences the value of the current applied to the light sources D1 through Dn.

The energy supply device 5 must therefore be connected to the lighting module 4 in order to ensure that at least a portion of the total supply current Iv flows across the shunt resistor Rsₑₓₜ. The shunt resistor Rsₑₓₜ is adapted to the brightness of the particular light sources D1 through Dn, and ensures that lighting modules 4 of different brightness classes are operated at different current levels, so that differences in brightness between the lighting modules 4 may be compensated for. It is thus possible to operate lighting modules 4 of different brightness classes at the same brightness, using identical supply devices 5, and at the same time to dispense with providing a coding resistor Rc that is to be externally contacted, and an associated evaluation unit 2. In addition, lighting modules 4 of different brightness classes may thus be used for a vehicle headlight, for example.

In view of this teaching, those skilled in the art are able to arrive at other embodiments of the invention (not shown) without inventive activity. The invention is therefore not limited to the embodiment shown. In addition, individual aspects of the invention or of the embodiment may be taken and combined with one another. The lighting module 4 and the energy supply circuit 5 involve a joint inventive concept. The concepts underlying the invention, which may be carried out in a variety of ways by those skilled in the art with an awareness of this description, and which are still maintained as such, are essential.

1. An energy supply circuit (5) for a lighting module (4) for a motor vehicle headlight, wherein the lighting module (4) includes a shunt resistor (Rsₑₓₜ) and at least one light source (D1, D2, Dn) that can be electrically supplied, at least partially, via the shunt resistor (Rsₑₓₜ), wherein the lighting module (4) also has at least three electrical connections (A1′, A2′, A3′), wherein a first connection (A1′) and a second connection (A2′) are provided for electrically contacting the shunt resistor (Rsₑₓₜ), and a third connection (A3′) is provided for electrically contacting the at least one light source (D1, D2, Dn) connected downstream, wherein the electrical connections (A1′, A2′, A3′) are designed as externally contactable connections, the energy supply circuit (5) comprising:
a control unit (3) for outputting a supply current (Iv), controlled to a constant value, to the at least one light source (D1, D2, Dn) of the lighting module (4), wherein the control unit (3) has at least three electrical connections (A1″, A2″, A3″) for connection to the electrical connections (A1′, A2′, A3′) of the lighting module (4), wherein the control unit (3) is configured for conducting at least a portion of the supply current (Iv) via the shunt resistor (Rsₑₓₜ) toward the at least one light source (D1, D2, Dn) and measuring the voltage difference (U_{Rsext}) present at the shunt resistor (Rsₑₓₜ), wherein for controlling the current (Iv), the voltage difference (U_{Rsext}) at the shunt resistor (Rsₑₓₜ) is controlled to a constant value,
wherein the control unit (3) has an auxiliary resistor (Rs) that is connected in parallel to the shunt resistor (Rsₑₓₜ).

2. The energy supply circuit (5) of claim 1, wherein the auxiliary resistor (Rs) is topologically accommodated within the control unit (3).

3. The energy supply circuit (5) of claim 1, wherein the auxiliary resistor (Rs) has a value between 0.1Ω and 2Ω.

4. The energy supply circuit (5) of claim 1, wherein the control unit (3) for controlling a supply current (Iv) that is output at the lighting module (4) has a transistor switch (T) connected in series with the lighting module (4), and a capacitor (C) connected in parallel.

5. A circuit arrangement comprising:
the energy supply circuit (5) of claim 1; and
a lighting module (4) for a motor vehicle headlight, wherein the lighting module has a shunt resistor (Rsₑₓₜ) and at least one light source (D1, D2, Dn) that can be electrically supplied, at least partially, via the shunt resistor (Rsₑₓₜ), wherein the lighting module (4) also has at least three electrical connections (A1′, A2′, A3′), wherein a first connection (A1′) and a second connection (A2′) are provided for electrically contacting the shunt resistor (Rsₑₓₜ), and a third connection (A3′) is provided for electrically contacting the at least one light source (D1, D2, Dn) connected downstream, wherein the electrical connections (A1′, A2′, A3′) are designed as externally contactable connections.

6. The circuit arrangement of claim 5, wherein the lighting module (4) has at least two, three, or more than three light sources.

7. The circuit arrangement of claim 5, wherein the at least one light source (D1, D2, Dn) is an LED, an OLED, or a laser diode.

8. The circuit arrangement of claim 5, wherein the shunt resistor (Rsₑₓₜ) has a value between 0.2Ω and 2Ω.

9. The circuit arrangement of claim 5, wherein the shunt resistor (Rsₑₓₜ), the at least one light source (D1, D2, Dn), and the at least three connections (A1′, A2′, A3′) are situated on a shared circuit carrier.

10. A motor vehicle headlight, comprising at least one energy supply circuit (5) of claim 1.

11. A motor vehicle having at least one, preferably two, motor vehicle headlights according to claim 10.

12. The energy supply circuit (5) of claim 3, wherein the auxiliary resistor (Rs) has a value between 0.15Ω and 1Ω.

13. The energy supply circuit (5) of claim 3, wherein the auxiliary resistor (Rs) has a value between 0.2Ω and 0.75Ω.

14. The circuit arrangement of claim 8, wherein the shunt resistor (Rsₑₓₜ) has a value between 0.3Ω and 1.50Ω.

15. The circuit arrangement of claim 8, wherein the shunt resistor (Rsₑₓₜ) has a value between 0.5Ω and 1Ω.

16. The circuit arrangement of claim 9, wherein the shared circuit carrier comprises a printed circuit board.

17. A motor vehicle headlight comprising at least one circuit arrangement of claim 5.

18. A motor vehicle having at least one, preferably two, motor vehicle headlights according to claim 17.
